(19) United States
(12) Patent Application Publication
(10) Pub. No.: US 2015/0261623 A1
(43) Pub. Date: Sep. 17, 2015

(54) METHOD AND DEVICE FOR RECOVERING DATA

(71) Applicant: MACRONIX INTERNATIONAL CO., LTD., Hsinchu (TW)

(72) Inventors: Chia-Tung Ho, New Taipei City (TW); Yu-Min Lee, Hsinchu City (TW)

(21) Appl. No.: 14/474,389

(22) Filed: Sep. 2, 2014

Related U.S. Application Data
(60) Provisional application No. 61/953,831, filed on Mar. 15, 2014.

(51) Int. Cl. G06F 11/14

(52) U.S. Cl. CPC G06F 11/1469; G06F 11/1451; G06F 2201/84

(57) ABSTRACT

A method for recovering data comprising the following steps: First, selecting a first basis set from a basis set. Then, recovering the data by the first basis set at a current sampling time point to generate a first estimated data. Next, recording a first resetting time point when an estimated error of the first estimated data at the current sampling time point exceeds a first threshold value. After that, when the estimated error of first estimated data exceeds a second threshold value, transferring the first basis set to a second basis set of the basis set and backtracking to the first resetting time point to recover the data by the second basis set to generate a second estimated data.

This application claims the benefit of U.S. provisional application Ser. No. 61/953,831, filed Mar. 15, 2014, the subject matter of which is incorporated herein by reference.

### TECHNICAL FIELD

The disclosure relates in general to methods and devices for recovering data, and more particularly to methods and devices utilizing basis set to recover data.

### BACKGROUND

Recovering, reconstructing, or acquiring the continuous data by using sparse recovering technique or compressed sensing needs utilizing chosen a basis set to recover data. When the chosen basis set is no longer suitable to recover the data during the dynamic recovery procedure, it needs to find another basis set to recover the continuous data. However, this will cause severe error and cannot successfully recover the continuous data while directly changing the basis set during the dynamic recovery procedure.

### SUMMARY

The disclosure is directed to methods and devices for recovering data. By seeking and using a past resetting time point which the estimated data obtained from the old basis set and the new basis set is quite similar, the old basis set can be transferred to the new basis set for recovering continuous data without the causing severe error and discontinuity. Moreover, the present invention provides a mechanism to mark the resetting time points during the continuous recovery procedure. When the estimated error is too big, the recovering procedure will automatically check the resetting time points whether it satisfies the condition of transferring basis.

According to one embodiment, a method for recovering data is provided. The method comprises the following steps. First, selecting a first basis set from a basis set. Then, recovering the data by the first basis set at a current sampling time point to generate a first estimated data. Next, recording a first resetting time point when an estimated error of the first estimated data at the current sampling time point exceeds a first threshold value. After that, when the estimated error of first estimated data exceeds a second threshold value, transferring the first basis set to a second basis set of the basis set and backtracking to the first resetting time point to recover the data by the second basis set to generate a second estimated data.

According to another embodiment, a method for recovering data is provided. The method comprises the following steps. First, selecting a first basis set from a basis set. Then, recovering the data at a current sampling time point by the first basis set to generate a first estimated data. Next, recording a plurality of resetting time points when an estimated error of the first estimated data exceeds a first threshold value. After that, when the estimated error of first estimated data exceeds a second threshold value, transferring the first basis set to a second basis set of the basis set and backtracking to a first resetting time point of the resetting time points to recover the data by the second basis set to generate a second estimated data.

According to an alternative embodiment, a device for recovering data is provided. The device comprises one or more processors and a memory storing a program. The program comprises instructions for selecting a first basis set from a basis set; instructions for recovering the data by the first basis set at a current sampling time point to generate a first estimated data; instructions for recording a first resetting time point when an estimated error of the first estimated data at the current sampling time point exceeds a first threshold value; instructions for transferring the first basis set to a second basis set of the basis set and backtracking to the first resetting time point to recover the data by the second basis set to generate a second estimated data when the estimated error of first estimated data exceeds a second threshold value.

### BRIEF DESCRIPTION OF THE DRAWINGS

FIG. 1 illustrates an exemplary flow diagram of a method for recovering data according to an embodiment of the present invention.

FIG. 2 illustrates exemplary voltage waveforms of a node.

FIG. 3 illustrates an example of relation between basis adjustment metric and basis adjustment metric difference.

FIG. 4 illustrates an example of adaptive error control of the method for recovering data according to an embodiment of the present invention.

FIG. 5 illustrates a flow chart of an adaptive error control of the method for recovering data.

FIG. 6A illustrates an exemplary voltage waveform recovered without using the recovering procedure of the present invention.

FIG. 6B illustrates an exemplary voltage waveform recovered by the recovering procedure of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

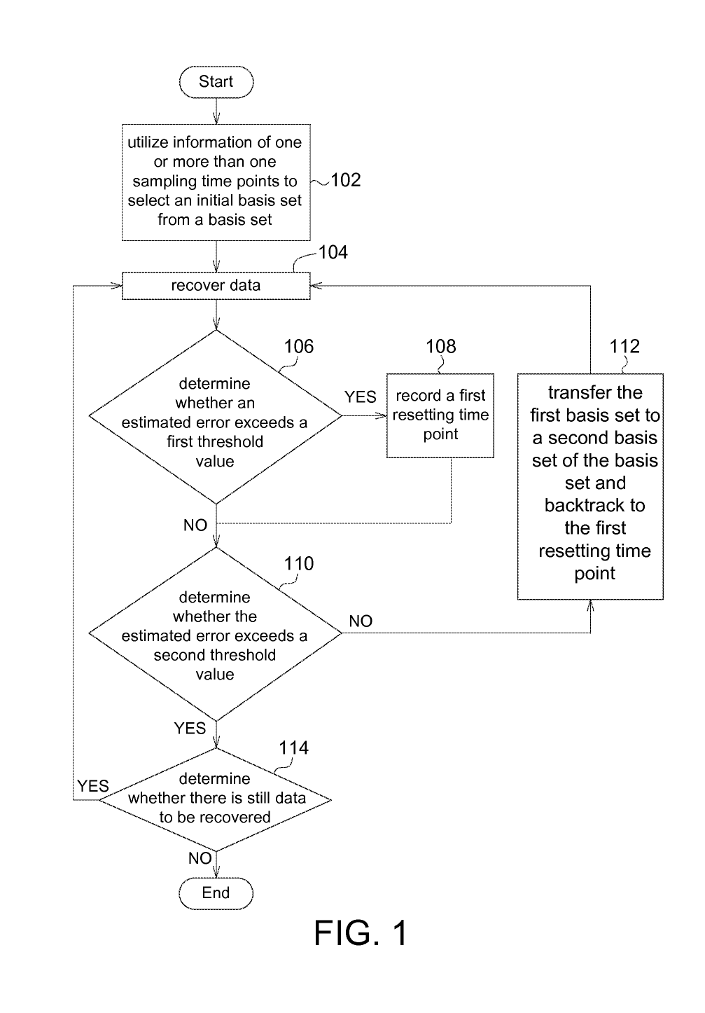

FIG. 1 illustrates an exemplary flow diagram of a method for recovering data according to an embodiment of the present invention. At step 102, information of one or more than one sampling time points is utilized to select an initial basis set S0 from a basis set A. The basis set A can be, for example, a system matrix of a circuit network for circuit simulation or a sensing matrix for signal processing. In a RLC power grid network analysis example, the information means the original electrical variable analysis results (ex., simulated nodal voltage or current values) before the modification of the RLC power grid network. A sampling circuit may be used to sample the nodal voltage or current waveforms of the RLC power grid network at one or more than one sampling time points to generate the abovementioned information. The basis set A includes a plurality of basis sets S0-Sn. These basis sets S0-Sn can be extracted from the basis set A by various methods, such as Orthogonal Matching Pursuit.

At step 104, the data is recovered. The recovered data may be stored in a storing unit, such as a memory, to be used in later recovering procedure. The data is continuous and time variant. In the example, the initial basis set S0 is selected to recover the data at a current time point Tc to generate a first estimated data. During the recovering procedure, an incremental transient simulation procedure may be executed by a computing unit such as a computer processor, a digital processor or an electrical device capable of executing circuit simulation or analysis.

At step 106, the computing unit determines whether an estimated error (of the first estimated data) at the current sampling time point Tc exceeds a first threshold value. If so, step 108 is executed, and a first resetting time point is recorded. Specifically, if the computing unit finds that the estimated error of the first estimated data at the current sampling time point Tc accrues a magnitude which exceeds the first threshold value, a first resetting time point is marked (ex., storing the first resetting time point into a table of a memory). The first resetting time point is earlier than the current sampling time point Tc at which the first estimated data accrues significantly. In another example, when the estimated error at the current sampling time point Tc exceeds the first threshold value, a few of resetting time points before the current sampling time point Tc are recorded. It is understood that there is a variety to determine the first threshold value for recording/marking the resetting time points, but they all stick with the same concept which is marking the sampling points that can backtrack to when the estimated error is unacceptable.

At step 110, the computing unit determines whether the estimated error (of the first estimated data) at the current sampling time point Tc exceeds a second threshold value. If so, step 112 is executed, and the computing unit transfers the first basis set to a second basis set of the basis set and backtracks to the first resetting time point, so that the data is recovered by the second basis set to generate a second estimated data at the first resetting time point (step 104). It is understood that there are different ways to measure whether the estimated error from the old basis set and the new basis set is small enough or not. Therefore, there may be lots of ways to decide the condition of transferring the basis set.

At step 114, the computing unit determines whether there is still data to be recovered. If so, the computing unit recovers the data at a next sampling time point Tc+1 (goes back to step 104). If not, the recovering procedure is finished.

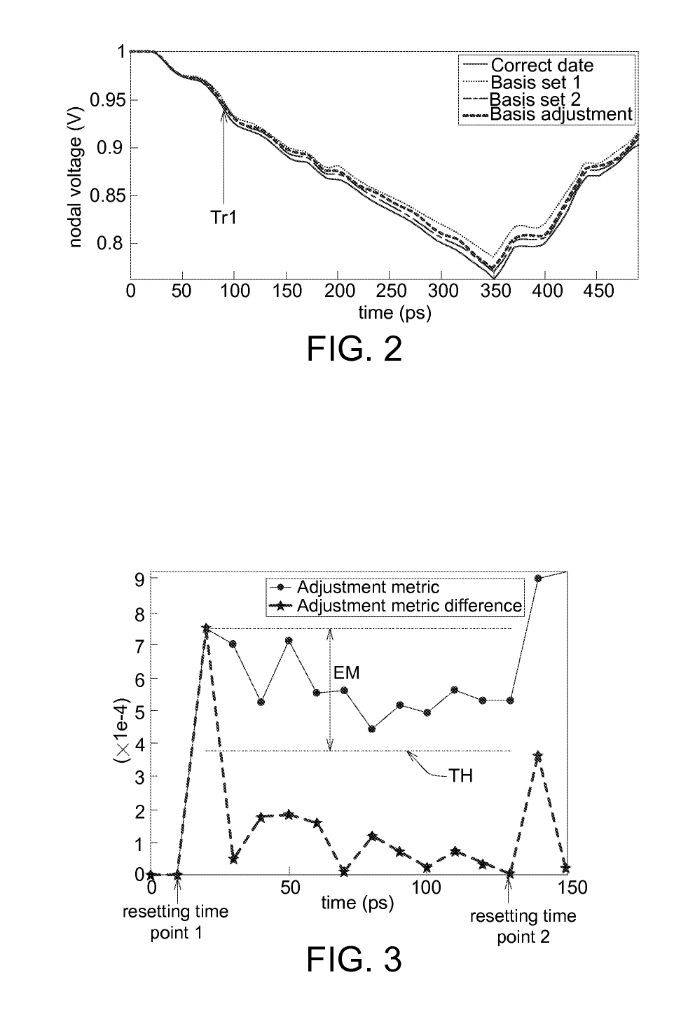

Given a power grid network that is solved by macro modeling technique and incrementally estimated by two basis sets 1 and 2, exemplary voltage waveforms of a node is shown in FIG. 2. In the example of FIG. 2, there are fewer bases in basis set 1 than in basis set 2. As a result, the voltage waveform estimated by basis set 1 may suffer more severe estimated error than basis set 2. If basis set 1 is selected to recover data (voltage wave form), it may need to transfer basis set 1 to basis set 2 for improving accuracy of estimation. To simultaneously maintain the accuracy requirement and ease the inconsistent problem while changing the basis set, the error gap between the estimated data by basis sets 1 and 2 must be small enough. In an example, if the estimated data by basis set 1 and basis set 2 satisfies the following criterion, the basis set adjustment (i.e. transferring basis set 1 to basis set 2) is allowed:

$$\vert Δ {v}_{1} - Δ {v}_{2} \vert \leq {10}^{- 3} \& \vert \frac{Δ {v}_{1} - Δ {v}_{2}}{Δ {v}_{1}} \vert \leq {10}^{- 4}$$

$$\vert Δ {i}_{1} - Δ {i}_{2} \vert \leq {10}^{- 6} \& \vert \frac{Δ {i}_{1} - Δ {i}_{2}}{Δ {i}_{1}} \vert \leq {10}^{- 4}$$

where Δv₁/Δi₁ and Δv₂/Δi₂ are the voltage/current values estimated by basis set 1 and basis set 2, respectively.

In the example of FIG. 2, it shows that the voltage waveforms estimated by basis set 1 and basis set 2 are substantially the same at the first resetting time point Tr1, and the accuracy of the estimated voltage waveform is improved after the first resetting time point Tr1 if the basis set is switched to basis set 2 at the resetting time point Tr1. Moreover, as can be seen from FIG. 2, the estimated voltage waveform by basis set 2 before the first resetting time point Tr1 is also substantially the same with the estimated voltage waveform estimated by basis set 1.

Because the basis set can be switched without causing severe error and discontinuity while the difference between the estimated data from the old (ex., basis set 1) and the new basis set (ex., basis set 2) is small enough, one or more resetting time points earlier than the first resetting time point Tr1 (ex., second resetting time point Tr2) can also be used to transfer the basis sets.

FIG. 3 shows an example of relation between basis adjustment metric and basis adjustment metric difference. Here, the basis adjustment metric at the j-th sampling time, γⁱ, is defined as the root mean square value of non-zero parts in the estimated error at the j-th sampling time, and the basis adjustment metric difference is defined as δⁱ=|γⁱ−γⁱ⁻¹|. Given a suitable basis set, generally, its basis adjustment metrics are within an error margin EM as shown in FIG. 3. When the basis adjustment metric difference changes significantly, it means that the basis set currently used is not suitable for estimating the data at the current sampling time and needs to be reset. Hence, as the basis adjustment metric difference changes significantly at the j-th sampling time, the (j−1)-th sampling time is memorized as a resetting time point.

With this scheme, as the estimated error exceeds the threshold (ex. TH), only the memorized resetting time points need to be checked. As shown in FIG. 3, the sampling time before the estimated error intending to drastically grow is saved as a resetting time point (ex., resetting time point 1 or 2) for resetting the basis set.

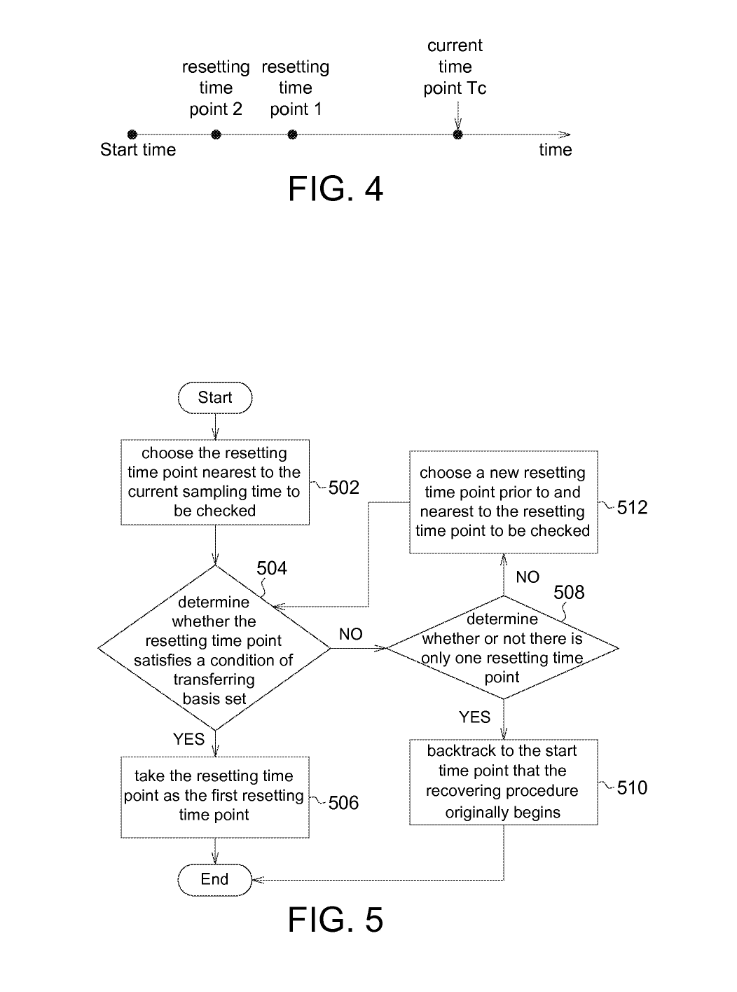

FIG. 4 shows an example of adaptive error control of the method for recovering data according to an embodiment of the present invention. In the example of FIG. 4, as the estimated error exceeds the threshold at the current sampling time point Tc, the recovering procedure executed by the computing unit goes back to the nearest resetting time point 1. If the error gap at the resetting time point 1 is small enough (ex. smaller than a threshold), the procedure will keep recovering the data for succeeding sampling times from the resetting time point 1. Otherwise, the procedure goes back further to check another potential basis resetting time point (ex., resetting time point 2).

FIG. 5 shows a flow chart of an adaptive error control of the method for recovering data. In the example FIG. 5, the resetting time points from farthest to nearest to the current sampling time point Tc are denoted as Tr(1), Tr(2), . . . , Tr(n), respectively, where n is a natural number. As earlier described, these resetting time points Tr(1)-Tr(n) are prior to the current sampling time point Tc.

At step 502, the resetting time point Tr(i) nearest to the current sampling time Tc is chosen to be checked, where i=n. At step 504, the computing unit determines whether the resetting time point Tr(i) satisfies a condition of transferring basis set, such as determining whether or not the estimated error at the resetting time point Tr(i) exceeds a threshold value. If so, the resetting time point Tr(i) is taken as the first resetting time point of FIG. 1 for recovering procedure at step 506. If not, the computing unit further determines whether or not there is only one resetting time point at step 508. At step 510, because there is no other resetting time point can be used, the computing unit backtracks to the start time point that the recovering procedure originally begins. In contrast, at step 512, the resetting time point Tr(i−1), which is nearest to the resetting time point Tr(i), is chosen to be checked by step 504. By the preceding adaptive error control scheme, the recovering procedure automatically checks the resetting time points whether it satisfies the condition of transferring basis set, so the procedure can backtrack to a suitable resetting time point to recover the data when the estimated error is too big.

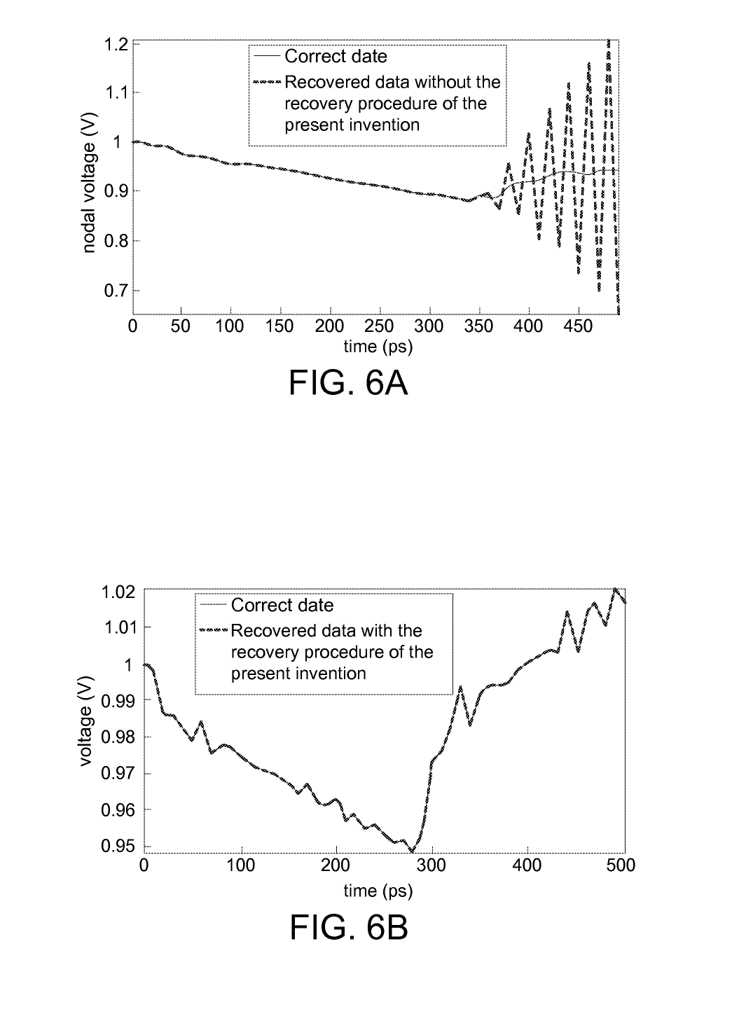

FIG. 6A shows an exemplary voltage waveform recovered without using the recovering procedure of the present invention. In the example of FIG. 6A, a test circuit with 40,000 nodes is generated by using the industrial parameters. After changing several element values, the incremental steady-state simulation method is directly extended to perform the incremental transient simulation, and the number of bases is changed from 1 6 to 53 at the time point 1. The voltage waveform at a node is shown in FIG. 6A. It can be observed that the voltage waveform at the node starts to move up and down after the time point 1.

FIG. 6B shows an exemplary voltage waveform recovered by the recovering procedure of the present invention. In the example of FIG. 6B, a test circuit with 1.6 million nodes is generated. The voltage waveform at a node is shown in this figure. It can be observed that the voltage waveform at the node substantially meets the curve of correct voltage waveform.

A device for recovering data is further provided according to the embodiments of the present invention. The device performs the method for recovering data of the present invention. The device comprises one or more processors and a memory storing a program. The program comprises instructions for selecting a first basis set from a basis set; instructions for recovering the data by the first basis set at a current sampling time point to generate a first estimated data; instructions for recording a first resetting time point when an estimated error of the first estimated data at the current sampling time point exceeds a first threshold value; instructions for transferring the first basis set to a second basis set of the basis set and backtracking to the first resetting time point to recover the data by the second basis set to generate a second estimated data when the estimated error of first estimated data exceeds a second threshold value.

Based on the above, the methods and devices for recovering data of the present invention can transfer the old basis set to the new basis set without the causing severe error and discontinuity by seeking and using a resetting time point which the estimated data obtained from the old basis set and the new basis set is quite similar. Moreover, the present invention provides a mechanism to mark the resetting time points during the continuous recovery procedure. When the estimated error is too big, the recovering procedure will automatically check the resetting time points whether it satisfies the condition of transferring basis.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for recovering data, comprising:
selecting a first basis set from a basis set;
recovering the data by the first basis set at a current sampling time point to generate a first estimated data;
recording a first resetting time point when an estimated error of the first estimated data at the current sampling time point exceeds a first threshold value; and
when the estimated error of first estimated data exceeds a second threshold value, transferring the first basis set to a second basis set of the basis set and backtracking to the first resetting time point to recover the data by the second basis set to generate a second estimated data.

2. The method according to claim 1, wherein the first resetting time point is earlier than the current sampling time point.

3. The method according to claim 2, further comprising:
determining whether the difference between the first and second estimated data at the first resetting time point exceeds a third threshold value; and
when the difference between the first and second estimated data exceeds the third threshold value, backtracking to a second resetting time point earlier than the first resetting time point and recovering the data by the second basis set.

4. The method according to claim 1, wherein the first and second estimated data are substantially the same at the first resetting time point.

5. The method according to claim 4, wherein an estimated data estimated by the second basis set at a past time point before the first resetting time point is substantially the same with an estimated data estimated by the first basis set at the past time point.

6. The method according to claim 1, wherein the step of transferring the first basis set to the second basis set comprises:
selecting the second basis set according to the estimated error of the first estimated data and the basis set.

7. The method according to claim 1, further comprising:
recovering the data at a next sampling time point when the estimated error of the first estimated data does not exceed the second threshold value.

8. The method according to claim 1, wherein the data is continuous.

9. A method for recovering data, comprising:
selecting a first basis set from a basis set;
recovering the data at a current sampling time point by the first basis set to generate a first estimated data;
recording a plurality of resetting time points when an estimated error of the first estimated data exceeds a first threshold value;
when the estimated error of first estimated data exceeds a second threshold value, transferring the first basis set to a second basis set of the basis set and backtracking to a first resetting time point of the resetting time points to recover the data by the second basis set to generate a second estimated data.

10. The method according to claim 9, wherein the resetting time points are earlier than the current sampling time point.

11. The method according to claim 10, further comprising:
selecting the resetting time point nearest to the current sampling time as the first resetting time point.

12. The method according to claim 10, further comprising:
choosing a first target resetting time point of the resetting time points to be checked;
determine whether the first target resetting time point satisfies a condition of transferring basis set; and
selecting the first target resetting time point as the first resetting time point when the first target resetting time point satisfies the condition of transferring basis set.

13. The method according to claim 12, further comprising:
choosing a second resetting time point of the resetting time points, which is prior to and nearest to the first target resetting time point, to be checked.

14. The method according to claim 9, wherein the first and second estimated data are substantially the same at the first resetting time point.

15. The method according to claim 14, wherein an estimated data estimated by the second basis set at a past time point before the first resetting time point is substantially the same with an estimated data estimated by the first basis set at the past time point.

16. The method according to claim 9, further comprising:
recovering the data at a next sampling time point when the estimated error of the first estimated data does not exceed the second threshold value.

17. The method according to claim 9, wherein the data is continuous.

18. A device for recovering data, comprising:
one or more processors; and
a memory storing a program, wherein the program is configured to be executed by the one or more processors, the program comprising:
instructions for selecting a first basis set from a basis set;
instructions for recovering the data by the first basis set at a current sampling time point to generate a first estimated data;
instructions for recording a first resetting time point when an estimated error of the first estimated data at the current sampling time point exceeds a first threshold value; and
instructions for transferring the first basis set to a second basis set of the basis set and backtracking to the first resetting time point to recover the data by the second basis set to generate a second estimated data when the estimated error of first estimated data exceeds a second threshold value.

19. The device according to claim 18, wherein the first resetting time point is earlier than the current sampling time point.

20. The device according to claim 19, wherein the program further comprises:
instructions for determining whether the difference between the first and second estimated data at the first resetting time point exceeds a third threshold value; and
instructions for backtracking to a second resetting time point earlier than the first resetting time point to recover the data by the second basis set when the difference between the first and second estimated data exceeds the third threshold value.
